(19) United States
(12) Patent Application Publication
(10) Pub. No.: US 2006/0173799 A1
(43) Pub. Date: Aug. 3, 2006

(54) Technique for prioritizing tasks in a postal service provider data center

(76) Inventor: Lodovico Minnocci, Hamden, CT (US)

Correspondence Address: PERMAN & GREEN, 425 POST ROAD, FAIRFIELD, CT, 06824, US

(21) Appl. No.: 11/047,434

(22) Filed: Jan. 31, 2005

(51) Int. Cl. G06F 17/00

(52) U.S. Cl. 705/404

(57) ABSTRACT

A postal service provider system includes a sever and a plurality of meters. The meters access the server to initiate tasks for data collection, reporting, and accounting purposes and the server prioritizes the tasks so as to service the meters efficiently.

### BACKGROUND

The disclosed exemplary embodiments relate to operating a postal service data center, and in particular to assigning priority to various tasks performed by the data center.

### BRIEF DESCRIPTION OF RELATED DEVELOPMENTS

A high volume postal customer may use a meter which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

A meter generally communicates with a remote data center to have funds replenished, to update data tables, or to add or update features. This communication is generally initiated by the meter. In a system having a data center servicing multiple meters, it would be advantageous to have a system for prioritizing requests for service from the meters in order to efficiently address those requests.

### SUMMARY OF THE EXEMPLARY EMBODIMENTS

The exemplary embodiments are directed to a postal service provider system including a server and a plurality of meters. The meters access the server to initiate tasks for data collection, reporting, and accounting purposes and the prioritizes the tasks so as to service the meters efficiently.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention; and

FIG. 2 shows a block diagram of an indicia producing device.

### DETAILED DESCRIPTION OF THE EXEMPLARY EMBODIMENTS

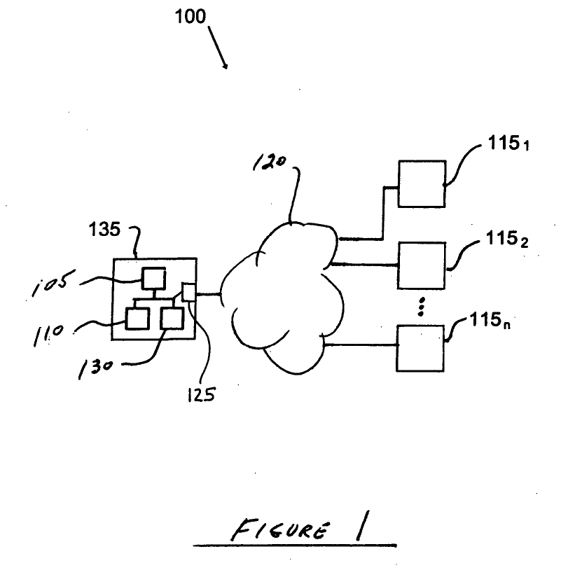

FIG. 1 shows a block diagram of a system 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 is a postal services provider system and includes one or more indicia producing or marking devices, shown in FIG. 1 as meters 115₁ . . . 115ₙ, and a remote data center, shown generally as a server 135.

It is a feature of the present invention for the meters 115₁, . . . 115ₙ to access the server 135 to initiate tasks for data collection, reporting, and accounting purposes. It is another feature of the present invention for the server to prioritize the tasks so as to service the meters 115₁ . . . 115ₙ efficiently.

Server 135 is generally operated by a postal service provider and may include a processor 105, a memory 110, and a database 130 for storing information. Processor 105 generally operates under the control of programs stored in memory 110 to manage operations of server 135. Server 135 generally provides updates, programs that allow additional functionality, replacement programs, data tables and other data and information to meters 115₁ . . . 115ₙ. In addition, server 135 may collect data from meters 115₁ . . . 115ₙ and provide reporting and accounting services to customers of the postal service provider.

Server 135 may be coupled to a data communications network 120. Data communications network 120 may include any suitable communications network, for example, the Public Switched Telephone Network (PSTN), a wireless network, a wired network, a Local Area Network (LAN), a Wide Area Network (WAN), virtual private network (VPN) etc. Server 135 may communicate with meters 115₁ . . . 115ₙ using any suitable protocol, or modulation standard, for example, X.25, ATM, TCP/IP, V34, V90, etc. When data communications network 120 is implemented as a wireless network, it generally incorporates an air interface utilizing any suitable wireless communication protocol or signaling techniques or standards, for example TDMA, CDMA, IEEE 802.11, Bluetooth, close range RF, optical, any appropriate satellite communication standards, etc.

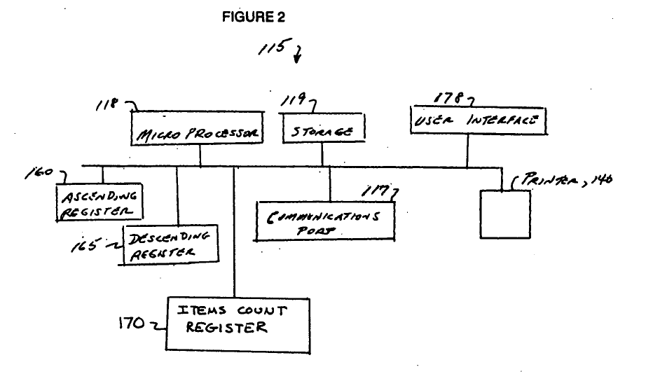

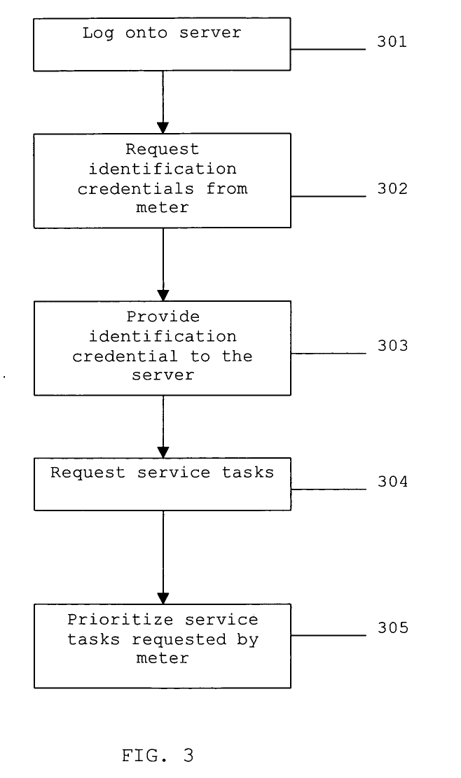

FIG. 2 shows a general block diagram of an individual meter 115. Meters 115₁ . . . 115ₙ generally provide indicia that has value, for example, postage, tickets allowing admission to an event or allowing the use of a service, etc. Meter 115 may include a communications port 117 and a microprocessor 118 for performing accounting, control, franking, and handling functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform functions associated with producing indicia. Storage device 119 may utilize optical, magnetic, semiconductor, electronic, or other types of suitable devices to store the program code.

As part of the meter's accounting functions, microprocessor 118 typically may record data related to franking items with indicia. Such data may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions typically include marking items with indicia and reporting the number of items, value marked and other parameters to the accounting functions.

The control functions generally include utilizing communications port 117 to communicate with server 135 through communications network 120.

Meters 115₁ . . . 115ₙ generally initiate communication with the server 135. A meter 115 may logon to the server 135 by addressing a message to the server requesting service. The server 135 may respond with a request for identification credentials. Upon supplying the proper identification credentials, meter 115 may be granted access.

Upon being granted access, the meter may request data collection, an update, for example a new rate table, or additional funds, also referred to as a reset.

According to the disclosed embodiments, because the meters may initiate communication at any time, server 135 may operate to manage its communication resources by prioritizing answering or acknowledging a communication initiation by a meter. In addition, the server may operate to prioritize the tasks required by a meter once communication is established.

Larger operations such as software downloads are network intensive and may take minutes to finish, while a reset may only require a few seconds. A reset may be given priority because it only requires a small amount of information exchange to complete. By giving requests that take less time to complete, the overall mean response time may be significantly reduced. Thus, by analyzing tasks based on their processing time, requests for service may be acknowledged and services may be provided efficiently.

For example, a first meter 115₁ may initiate communication to request an operating system update which may take approximately 10 minutes to complete. Server 135 may acknowledge the request and begin the download. After approximately 2 minutes, a second meter 115₂ may intiate communication with server 135 and request a reset which may take approximately 1 minute. The server recognizes that servicing the second meter 115₂ will take less time to complete than completing the download to the first meter 115₁ and so suspends the download to the first meter 115₁ and provides the reset to the second meter 115₂. Upon completion of the reset, the server 135 resumes the download to the first meter 115₁. The impact on the downlaod is minimal and the reset is accomplished quickly.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A postal service provider system comprising:
server; and
a plurality of meters, wherein the meters access the server to initiate tasks for data collection, reporting, and accounting purposes and the server prioritizes the tasks so as to service the meters efficiently.

2. The system of claim 1, wherein the server is configured to prioritize answering communication initiations by the plurality of meters.

3. The system of claim 1, wherein the server is configured to prioritize the tasks based on a processing time of the tasks.

4. The system of claim 3, wherein the server is configured to suspend one task to complete another task.

5. The system of claim 1 further comprising a network for communication between the server and the plurality of meters.

6. A postage meter comprising:
a microprocessor; and
a communications port connected to the microprocessor for communicating with a server;
wherein, the postage meter is configured to allow communication initiations made by the postage meter to be prioritized by the server.

7. A postal services data center comprising:
a processor; and
a communications port for transmitting and receiving data to and from a plurality of meters;
wherein, the postal services data center is configured to receive and answer communication initiations from the plurality of meters and prioritize tasks associated with the communication initiations so as to service the meters efficiently.

8. The postal services data center of claim 7, wherein the postal services data center is further configured to prioritize answering communication initiations by the plurality of meters.

9. The postal services data center of claim 7, wherein the postal services data center is further configured to prioritize the tasks based on a processing time of the tasks.

10. The postal services data center of claim 9, wherein the postal services data center is configured to suspend one task to complete another task.

11. The postal services data center of claim 7, wherein the postal services data center is configured to collect data from the plurality of meters for reporting and accounting services.

12. A method for prioritizing tasks in response to a request for service by one or more postage meters comprising:
the one or more postage meters logging on to a server for a communications request;
the one or more postage meters requesting service tasks from the server; and
the server prioritizing the service tasks requested by the one or more postage meters so as to service the one or more postage meters efficiently.

13. The method of claim 12, wherein logging onto the server comprises:
addressing a message from the one or more postage meters to the server;
the server requesting identification credentials from the one or more postage meters; and
providing the server with the requested identification credentials from the one or more postage meters.

14. The method of claim 12, wherein the service tasks are prioritized based on a processing time of the tasks.

15. The method of claim 14, further comprising suspending one task to complete another task.

16. The method of claim 12, wherein the communications request is initiated by the one or more postage meters.

17. The method of claim 12, wherein more than one of the one or more postage meters initiates the communications request simultaneously.

18. The method of claim 17, further comprising the server prioritizing answering the communications requests of the one or more postage meters.

19. The method of claim 17, further comprising suspending a task of one of the one or more meters to complete a task of another of the one or more meters.
